(19) United States
(12) Patent Application Publication
(10) Pub. No.: US 2009/0132286 A1
(43) Pub. Date: May 21, 2009

(54) FREQUENTLY USED AND MODIFIED ELECTRONIC MEDICAL RECORDS SYSTEM AND ASSOCIATED METHODS

(75) Inventor: Andre D. Blaquier, Summerfield, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(73) Assignee: Integrated Information Services, Inc., Summerfield, FL (US)

(21) Appl. No.: 12/265,181

(22) Filed: Nov. 5, 2008

Related U.S. Application Data
(60) Provisional application No. 60/985,742, filed on Nov. 6, 2007.

(51) Int. Cl. G06Q 50/00

(52) U.S. Cl. 705/3

(57) ABSTRACT

The present invention is directed to a system and methods for creating and maintaining electronic medical records in an environment where the records are frequently used and modified. The system is envisioned for use with medical records that particularly, but not necessarily wholly, pertain to physical therapy, occupational therapy, and speech and language pathology patients. The system includes software for facilitating entry of both patient and treatment data. Such data can be entered into the system in a myriad of ways, including by voice, keyboard, mouse, and touch screen. The system also includes software for creating dynamic, updateable templates that can be used to automatically populate screens and electronic forms to help in the treatment of patients.

### CROSS-REFERENCE TO RELATED APPLICATION

This application claims priority to provisional application No. 60/1985,742, filed Nov. 6, 2007, entitled Voice-Activated Medical System and Associated Methods.

### COPYRIGHT NOTICE

A portion of the disclosure of this patent document contains material which is subject to copyright protection. The copyright owner has no objection to facsimile reproductions by anyone of the patent document or patent disclosure as it appears in the Patent and Trademark Office patent files and records, but otherwise reserves all copyright rights whatsoever.

### BACKGROUND OF THE INVENTION

1. Field of the Invention

The present invention relates to an electronic system and related methods for managing medical records, and more particularly to such systems and methods that require frequent use and modification.

2. Description of Related Art

The maintenance of medical records in many cases is still an area of difficulty and confusion. Cumbersome file folders make it difficult to coordinate scheduling and billing operations and inhibit medical treatment personnel from retrieving data quickly and consistently. Efforts to enter data into electronic records in a consistent way has also presented difficulties. This can be particularly a problem in the fields of physical therapy, occupational therapy, and speech and language pathology treatment.

The fields of physical therapy, occupational therapy, and speech and language pathology treatment usually require multiple treatment sessions with a patient over a short period of time relative to treatment sessions in other medical fields. For example, in these three fields it is possible that a clinician will need to treat a patient multiple times over a six to eight week period, with three or more treatment sessions being performed in a given week. As the patient progresses through the treatment plan, the plan needs to be modified to take into account the patient's changing medical condition. In addition, new diagnoses may be required, as well as adjustments to the stated goals for recovery. Each of these modifications can require an associated change to the patient's medical records.

It would be desirable, therefore, to provide a system and method that facilitates the easy creation and frequent maintenance of electronic medical records.

### SUMMARY OF THE INVENTION

The present invention is directed to a system and methods for creating and maintaining electronic medical records in an environment where the records are frequently used and modified. The system is envisioned for use with medical records that particularly, but not necessarily wholly, pertain to physical therapy, occupational therapy, and speech and language pathology patients. The system includes software for facilitating the convenient and rapid entry and modification of patient and treatment data. This can be accomplished by a number of means, including by voice command, by keyboard, and by pointing device, as well as by other input means.

Users of the system are divided into categories. The category to which a user belongs dictates the access that user has to the various screens, forms, and functions of the system. Since screens, forms, and functions required by one discipline might not necessarily be useful to one belonging to a different discipline, the system's categorization of users would seem to argue for a more orderly access to the system and an increased productivity among system users. Despite this categorization strategy, however, the system still offers flexibility. For example, in some instances the system provides a user of one discipline the ability to access areas and capabilities defined to another discipline.

In keeping with this theme of flexibility, the system also provides facilities, such as software modules and updateable templates, that can be used to automatically populate screens and electronic forms. Some of these facilities are directed to administrative tasks like salaries and billing, while others are directed to the treatment of patients. The system provides updateable templates, for example, to help a clinician perform such tasks as diagnosing a patient's ailment, preparing a treatment plan, and outlining a set of clearly defined short-term and long-term goals for recovery.

Using such updateable templates decreases data entry time, which increases clinician productivity. And since updateable templates can be shared among therapists and other users, the opportunity for finding better and faster ways of doing common tasks is consistently present.

### BRIEF DESCRIPTION OF THE DRAWINGS

The novel features which are believed to be characteristic of this invention are set forth with particularity in the appended claims. The invention itself, however, both as to its organization and method of operation, together with further objects and advantages thereof, may best be understood by reference to the following description taken in connection with the accompanying drawings. It is to be expressly understood, however, that the drawings are for the purpose of illustration and description and not intended as a definition of the limits of the invention.

FIG. 1 is a schematic diagram for a medical records system, in accordance with the present invention.

FIG. 2 is a flowchart showing a method of use for the system of FIG. 1.

FIG. 3 is an exemplary screen for logging onto the system of FIG. 1.

FIG. 4 is a portion of an exemplary screen for accessing the screen shown in FIG. 3 by way of a shortcut icon.

FIG. 5 is an exemplary screen for gaining access to major functions of the system of FIG. 1.

FIG. 6 is an exemplary screen for adding a user, such as a therapist, to the system of FIG. 1.

FIG. 7 is an exemplary screen for gaining access to time-and-wage related information for a user of the system of FIG. 1, such as a therapist.

FIG. 8 is an exemplary screen for displaying time utilization goals for a list of therapists.

FIG. 9 is an exemplary screen for gaining access to major functions largely related to patient care information.

FIG. 10 is an exemplary screen for maintaining information pertaining to a Therapist's pay schedule.

FIG. 11 is an exemplary screen for assigning a therapist to a facility and a team.

FIG. 12 is an exemplary screen for defining worksheets for system-wide use.

FIG. 13 is an exemplary screen for creating a treatment plan table.

FIG. 14 is an exemplary screen for creating a goals table.

FIG. 15 is an exemplary screen for creating a comorbidity table.

FIG. 16 is an exemplary screen for creating a customized billing charge ticket.

FIG. 17 is an exemplary screen for adding a patient to the system of FIG. 1.

FIG. 18 is an exemplary screen for manually adding a patient to the system of FIG. 1.

FIG. 19 is an exemplary screen for saving a patients biographical information to the system of FIG. 1.

FIG. 20 is an exemplary screen for selecting a patient for whom a file folder is to be created.

FIG. 21 is an exemplary screen for creating a file folder for a patient.

FIG. 22 is an exemplary screen for displaying a worksheet menu.

FIG. 23 is an exemplary screen for displaying a worksheet form prior to printing.

FIG. 24 is an exemplary screen for displaying a selection of physical therapy bodily regions.

FIG. 25 is an exemplary screen for displaying a therapy diagnosis list for a musculoskeletal aspect of the lumbar region.

FIG. 26 is an exemplary screen displaying notes entered into a patient evaluation.

FIG. 27 is an exemplary screen displaying a portion of the patient evaluation where a treatment plan can be entered.

FIG. 28 is an exemplary screen for displaying treatment plan progression and justification elements.

FIG. 29 is an exemplary screen for displaying short-term and long-term goals of a treatment plan.

FIG. 30 is an exemplary screen for selecting comorbidities.

FIG. 31 is an exemplary screen for displaying billing information.

FIG. 32 is an exemplary screen for displaying the entry of billing information into the patient evaluation.

FIG. 33 is an exemplary screen for displaying the creation of a new template.

FIG. 34 is an exemplary screen for displaying the selection of a template format.

FIG. 35 is an exemplary screen for displaying templates.

FIG. 36 is an exemplary screen for creating a customizable evaluation.

### DETAILED DESCRIPTION OF THE PREFERRED EMBODIMENTS

It should be noted that herein the term “comorbidity” is defined as the presence of a coexisting or additional disease that can impact a primary disease.

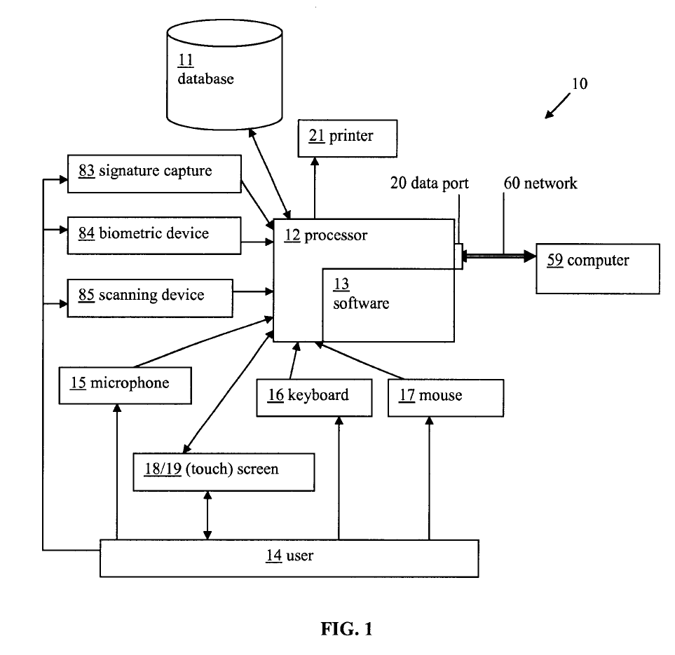

A description of the preferred embodiments of the present invention will now be presented with reference to FIGS. 1-36. Note that exemplary screen images that are presented herein are not intended to be limiting on the scope of the invention. As one skilled in the art will recognize, such images can be constructed differently without departing from the spirit of the invention.

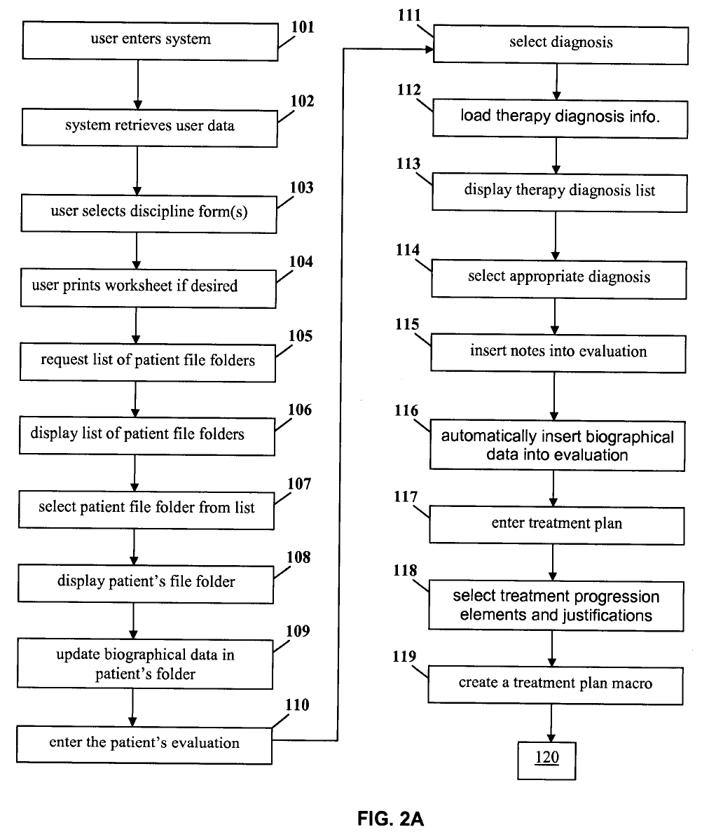

Embodying the principles of the present invention is an optionally voice-activated system 10 (see FIG. 1) and method 100 (see FIG. 2) for establishing, using, and maintaining a medical records database 11 (see FIG. 1). In a particular embodiment, not intended to be limiting, the system 10 is used for establishing, using, and maintaining a database of patient information and for initiating billing operations, among other purposes. The patients are intended to be, but are not limited to, physical therapy, occupational therapy, and speech and language pathology patients.

Referring now to FIG. 1, the system 10 in a particular embodiment comprises a processor 12 in signal communication with the medical records database 11. A software package 13 is resident on the processor 12 for implementing the method for establishing, using, and maintaining 100 (see FIG. 2) the database 11. The software package 13 comprises a plurality of code segments and modules adapted for carrying out the method 100. A user 14 interfaces with the processor 12 by any number of means. Such interfacing means include those means known in the art for signal connection with a processor 12, such as, but not limited to, speaking into a microphone 15, keying a keyboard 16, manipulating a mouse 17, manipulating a touch screen 18, offering a signature for capture 83, consenting to scanning by a biometric device 84, and operating a scanning device 85. Output can be provided by, but is not limited to, a display screen 19, a data port 20, a printer 21, and other output means known in the art for signal communication with a processor 12. Note that the display screen 19 may or may not comprise a touch screen 18.

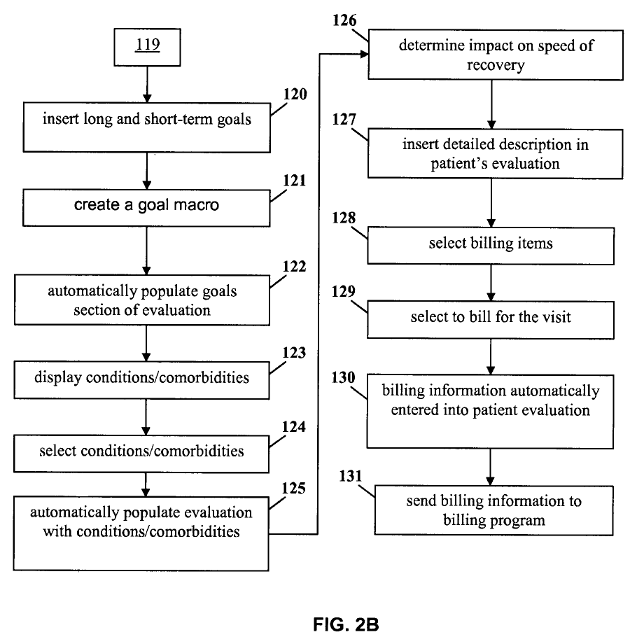

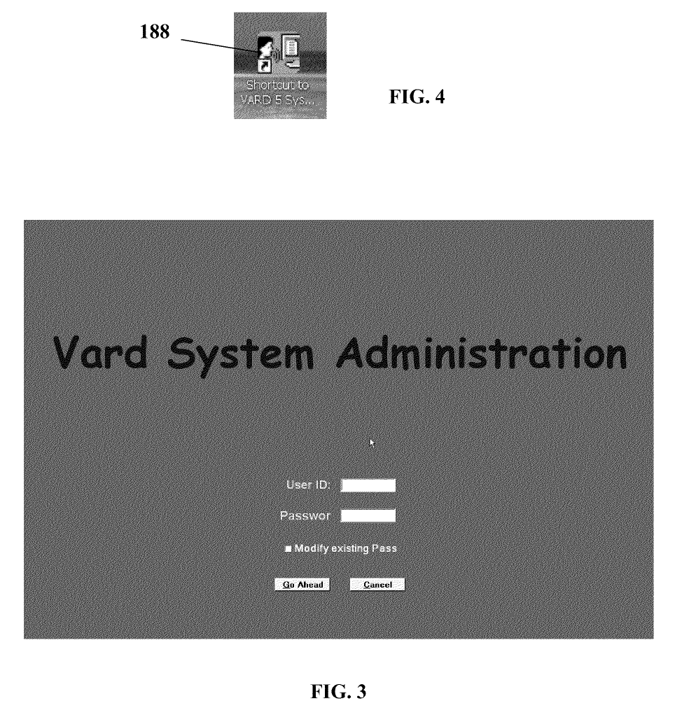

Referring now to FIG. 3, a user 14 (see FIG. 1) gains access to the system 10 (see FIG. 1) through a logon screen. The user 14 can access the screen directly, or the user 14 can use a shortcut icon 188 (see FIG. 4) to access the logon screen. Using the screen to logon to the system 10 is accomplished by means known in the art, preferably by entering a user ID and a password (step 101; see FIG. 2A).

Continuing with FIG. 3, the software package 13 (see FIG. 1) permits a user 14 (see FIG. 1) of the system 10 (see FIG. 1) to access various categories of data and system functionality based upon certain system-defined credentials previously assigned to the user 14, as is known in the art. One category of user 14 with broad access credentials is a system administrator 14. The system administrator 14 uses the logon screen depicted in FIG. 3 to access the system 10, while other categories of users 14, such as therapists, use a logon screen similar to the screen depicted in FIG. 3.

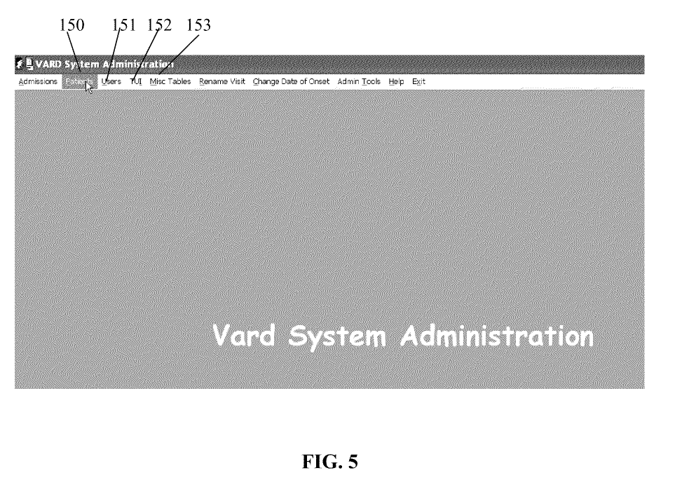

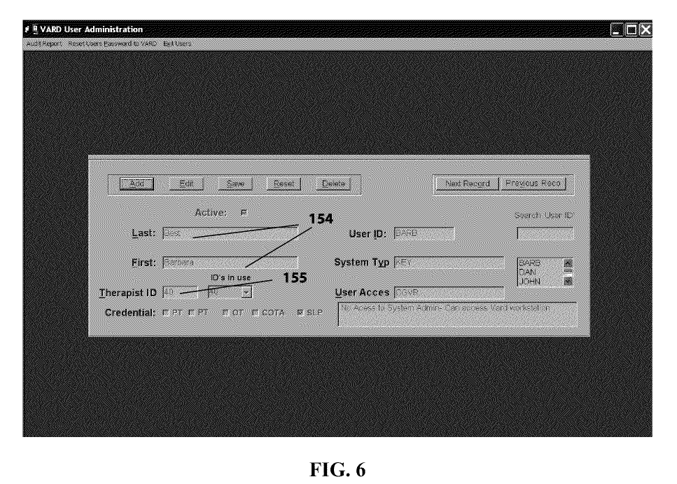

Referring now to FIG. 5, among tasks the system administrator 14 (see FIG. 1) can perform are the tasks of adding therapists 14 to the system 10 (see FIG. 1), defining access credentials assigned to the therapists 14, and defining various system-specific characteristics of the therapists 14. After the system administrator 14 has successfully logged onto the system 10, the system administrator 14 is taken to a System Administration screen. Using this screen, the system administrator 14 is able to gain access to a screen that will allow the system administrator 14 to add a therapist 14 to the system 10 (see FIG. 1) and to configure the credentials of the therapist 14. To do so, the system administrator 14 first selects a Users tab 151 on the System Administration screen. This takes the system administrator 14 to a User Administration screen (see FIG. 6).

Referring now to FIG. 6, the system administrator 14 (see FIG. 1) uses the User Administration screen to add such information as the name 154 of the therapist 14 and a therapist ID 155. The system administrator 14 also uses the User Administration screen, along with other related screens, to define the access credentials of the therapist 14, hourly salary rate, salaried status, team assignment, and data pertaining to the therapist's 14 access to the system, such as whether by voice commands or by other means such as a keyboard.

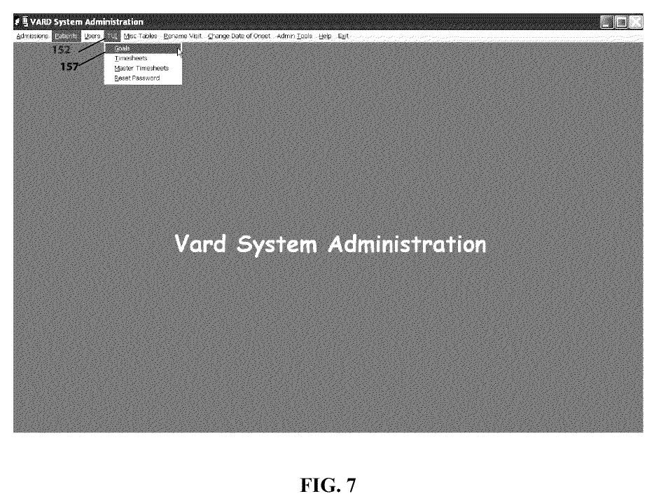

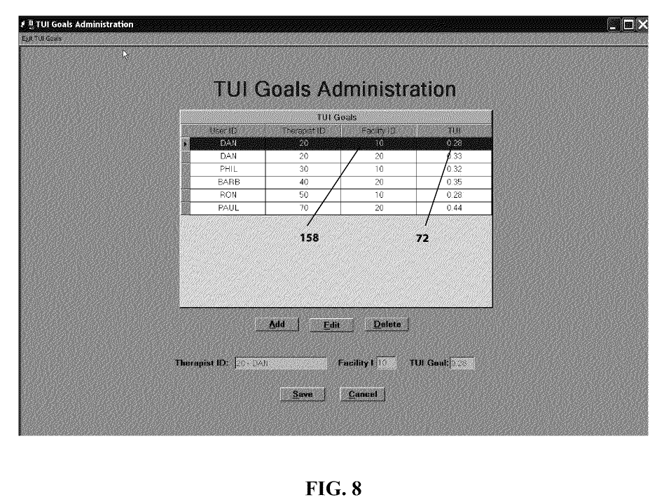

Referring now to FIGS. 7 and 8, the system administrator 14 (see FIG. 1) reenters the System Administration screen (see FIG. 7) to enter more information for the therapist 14. Here, the system administrator 14 selects a Goals option 157 (see FIG. 7) under a TUI tab 152 (see FIG. 7). This takes the system administrator 14 to a TUI Goals Administration screen (see FIG. 8). On the TUI Goals Administration screen, the new therapist 14 is further assigned a Facility ID 158 (see FIG. 8) and a time utilization Index (“TUI”) 72 (see FIG. 8). The TUI 72 is a productivity tool that takes the hourly salary of a therapist 14 and multiplies it by the hours worked in a day, then divides that amount by the total revenue generated by the therapist 14.

Regarding FIGS. 7 and 8, multiple categories of users 14 can be defined to the system 10 (see FIG. 1), and each category can have different access credentials. Note that sensitive data, such as salary information, might be hidden from some categories of users 14 who have access to the TUI Goals Administration screen but are without proper system credentials.

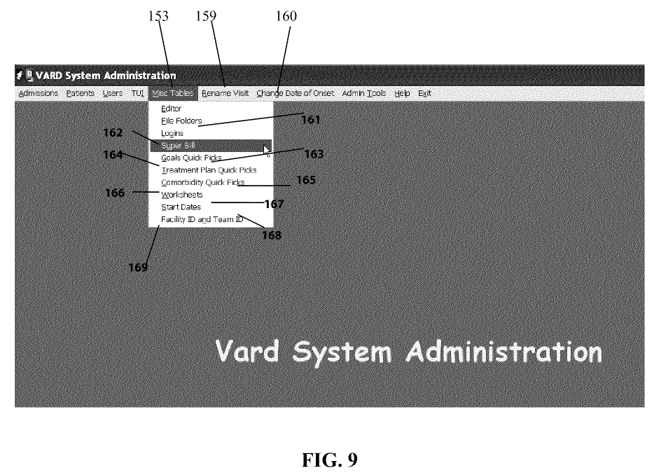

Referring now to FIG. 9, selecting a Misc Tables tab 153 on the System Administration screen displays a list of options 169 that are accessible to the system administrator 14 (see FIG. 1) and are used for maintaining various aspects of the system 10 (see FIG. 1). Some of the listed options 169 can be used when adding or updating information pertaining to a therapist 14.

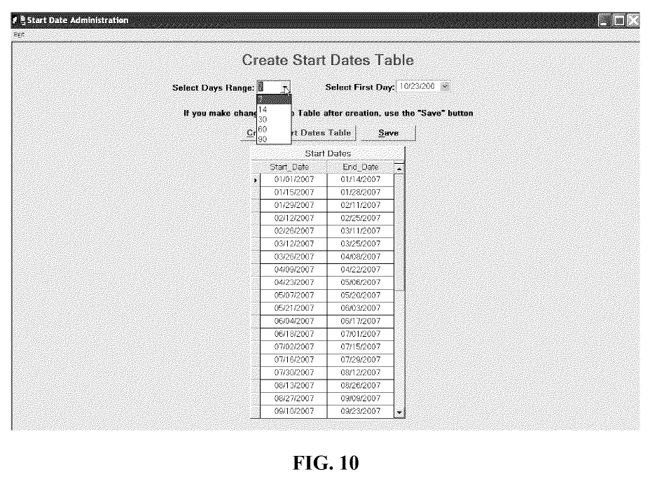

Referring now to FIG. 10, selecting a Start Dates option 167 (see FIG. 9) from the list of options 169 (see FIG. 9) on the System Administration screen (see FIG. 9) transfers the system administrator 14 (see FIG. 1) to a screen where a Start Dates Table is maintained. The Start Dates Table works with a Time Sheet module to show how a therapist's 14 time sheet will appear based upon a given pay period, such as weekly, biweekly, monthly, or bimonthly.

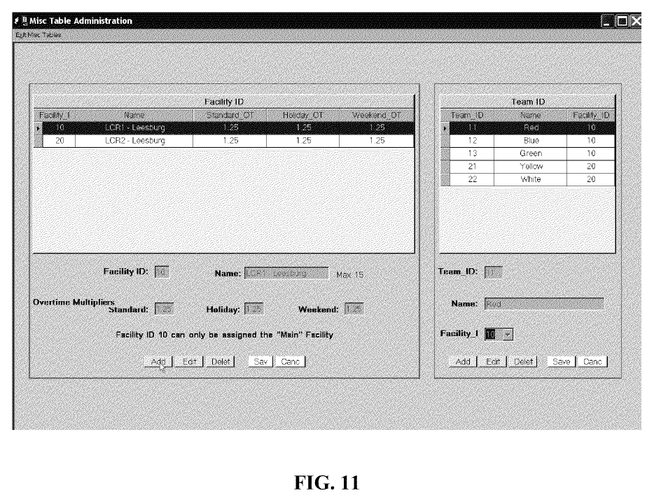

Referring now to FIG. 11, selecting a Facility ID and Team ID option 168 (see FIG. 9) from the list of options 169 (see FIG. 9) on the System Administration screen (see FIG. 9) transfers the system administrator 14 (see FIG. 1) to a screen where a Facility ID Table and a Team ID Table can be maintained. The Facility ID Table assigns a therapist 14 to a facility. The Team ID Table assigns a therapist 14 to a team. Note that the system administrator 14 can also use the Facility ID Table to define overtime multipliers for non-salaried therapists 14.

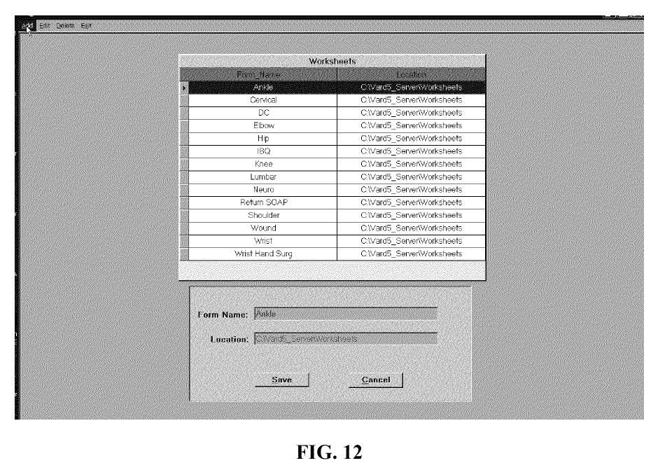

Referring now to FIG. 12, selecting a Worksheets option 166 (see FIG. 9) from the list of options 169 (see FIG. 9) on the System Administration screen (see FIG. 9) transfers the system administrator 14 (see FIG. 1) to a screen where worksheets can be defined. This screen gives the system administrator 14 the ability to create custom worksheets, which are then made available to therapists 14 across the system 10 (see FIG. 1).

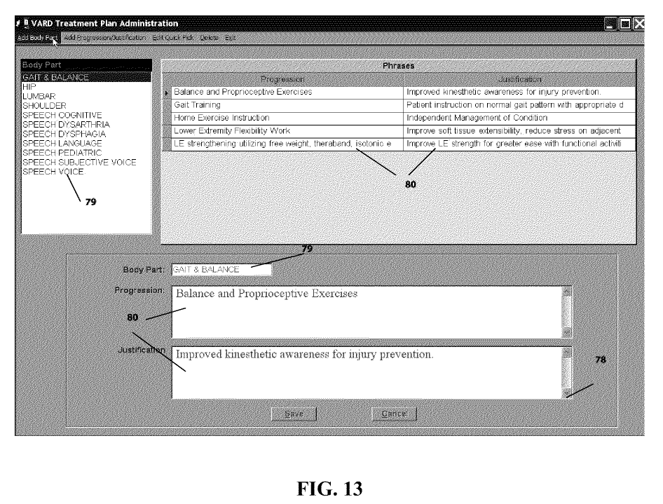

Referring now to FIG. 13, selecting a Treatment Plan Quick Picks option 164 (see FIG. 9) from the list of options 169 (see FIG. 9) on the System Administration screen (see FIG. 9) transfers the system administrator 14 (see FIG. 1) to a Treatment Plan Administration screen. This screen is used to maintain a Treatment Plan Quick Picks Table 78. The Treatment Plan Quick Picks Table 78 displays body parts 79 and phrases 80 that can be customized by therapists 14 and that is made available to therapists 14 across the system 10 (see FIG. 1).

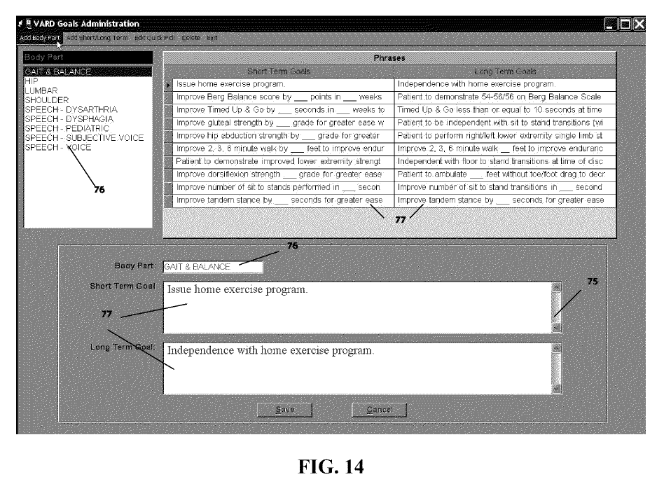

Referring now to FIG. 14, selecting a Goals Quick Picks option 163 (see FIG. 9) from the list of options 169 (see FIG. 9) on the System Administration screen (see FIG. 9) transfers the system administrator 14 (see FIG. 1) to a Goals Administration screen. This screen is used to maintain a Goals Quick Picks Table 75. The Goals Quick Picks Table 75 displays body parts 76 and phrases 77 that can be customized by therapists 14 and that is made available to therapists 14 across the system 10 (see FIG. 1).

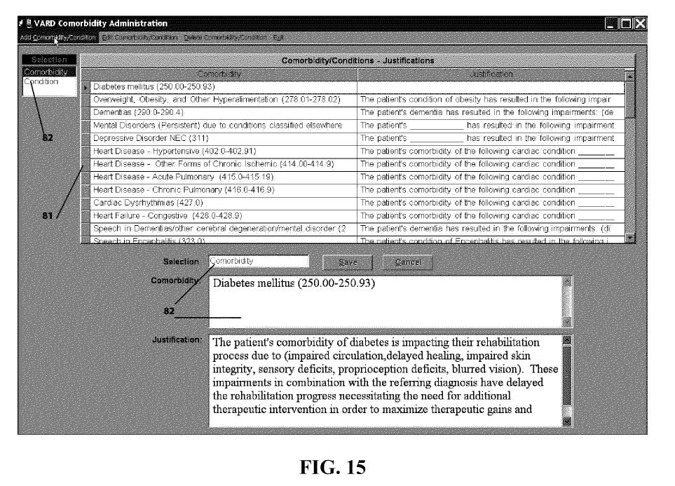

Referring now to FIG. 15, selecting a Comorbidity Quick Picks option 165 (see FIG. 9) from the list of options 169 (see FIG. 9) on the System Administration screen (see FIG. 9) transfers the system administrator 14 (see FIG. 1) to a Comorbidity Administration screen. This screen is used to maintain a Comorbidity Quick Picks Table 81. The Comorbidity Quick Picks Table 81 displays comorbidities and conditions 82 that can be customized by therapists 14 and that is made available to therapists 14 across the system 10 (see FIG. 1).

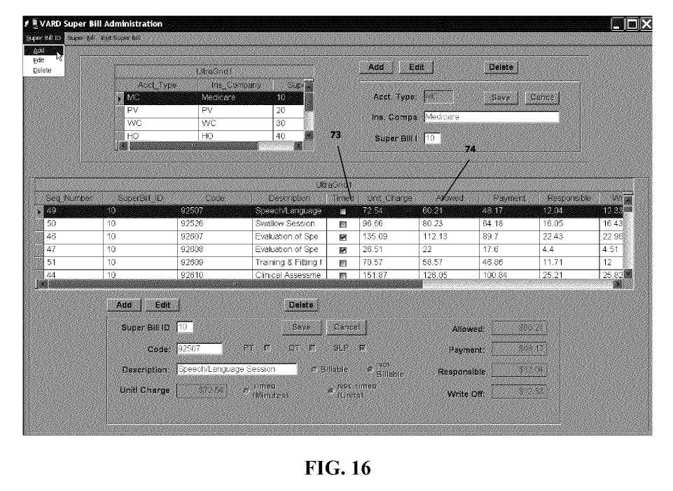

Referring now to FIG. 16, selecting a Super Bill option 162 (see FIG. 9) from the list of options 169 (see FIG. 9) on the System Administration screen (see FIG. 9) transfers the system administrator 14 (see FIG. 1) to a Super Bill Administration screen. This screen allows for the creation of a customized billing charge-ticket known as a superbill. Ordinary charges and allowed charges 74 both may be entered into a superbill. Allowed charges 74 are charges that a third party payer is willing to pay. The system administrator 14 can define which treatment elements are classified as timed 73 elements in a superbill. The system administrator 14 can also set accessibility parameters that define which disciplines are given access to which current procedural terminologies (“CPTs”) and descriptions. The system administrator 14 also has the authority to add, edit, or delete a superbill.

Referring now to FIG. 9, selecting a File Folders option 161 from the list of options 169 transfers the system administrator 14 (see FIG. 1) to a screen where medical records can be archived and where archived medical records can be returned to active status.

Continuing with FIG. 9, selecting a Rename Visit tab 159 on the System Administration screen transfers the system administrator 14 (see FIG. 1) to a screen where the system administrator 14 can rename medical records.

Still referring to FIG. 9, selecting a Change Date of Onset tab 160 on the System Administration screen transfers the system administrator 14 (see FIG. 1) to a screen where the system administrator 14 can modify an onset date in a selected medical record.

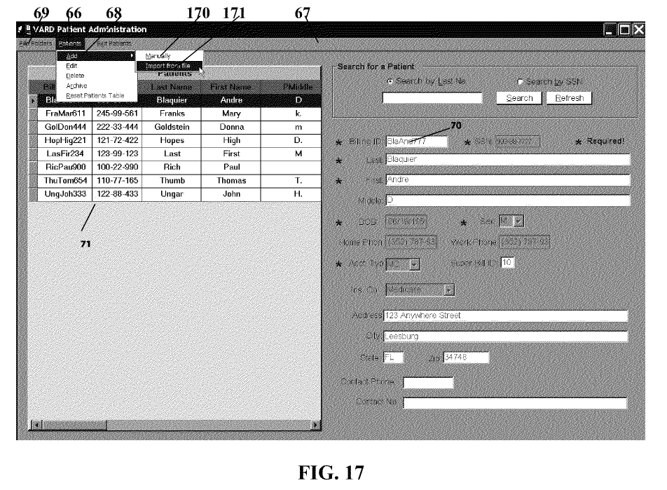

Referring now to FIG. 5, among the tasks that the system administrator 14 (see FIG. 1) can perform is the task of adding new patients to the database 11 (see FIG. 1) of the system 10 (see FIG. 1). To add a patient, the system administrator 14 selects a Patients tab 150 on the System Administration screen. This takes the system administrator 14 to a Patient Administration screen (see FIG. 17).

Referring now to FIG. 17, on the Patient Administration screen the system administrator 14 (see FIG. 1) selects an Add option 68 from a Patients menu 66 on a Patient Administration toolbar 67. The Add option 68 displays two additional options, Manually 170 and Import from file 171. The system administrator 14 selects the Manually option 170 to add the patient manually.

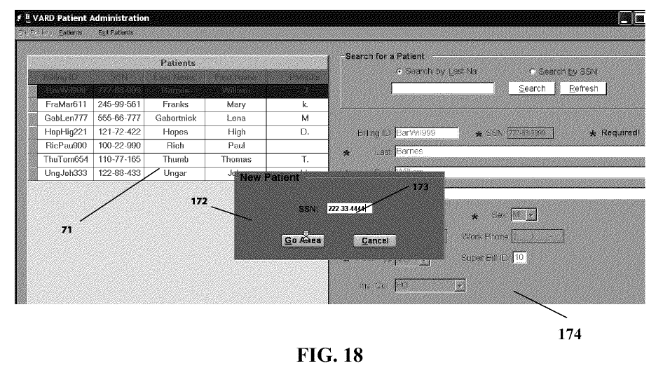

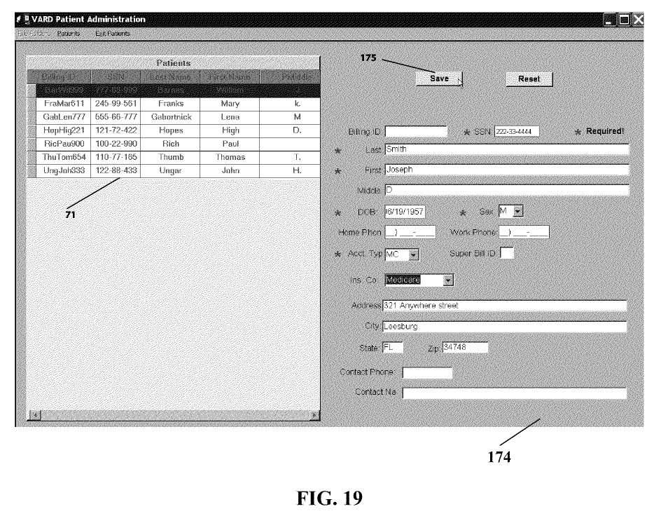

Referring now to FIGS. 18-20, a New Patient window 172 (see FIG. 18) is now displayed requesting a social security number 173 for the new patient. The system administrator 14 (see FIG. 1) enters the social security number 173 in the window 172. This action gives the system administrator 14 access to a biographical data entry area 174 of the screen where biographical information for the new patient can be entered. The system administrator 14 enters the biographical information and clicks the Save button 175 (see FIG. 19), whereupon the new patient is added to a Patients Table 71. A portion of the Patients Table 71 is displayed on the screen. When the new patient is added, the Patients Table 71 is refreshed on the screen to show the newly-added patient among the other patients who have been previously added to the database 11 (see FIG. 1).

Regarding FIGS. 18-20, note that it is possible for the system credentials of users 14 who are not system administrators 14 to be configured so as to allow these users 14 the ability to manually add new patients to the database 11.

Referring now to FIG. 17, alternatively the system administrator 14 (see FIG. 1) can add a new patient to the database 11 (see FIG. 1) using information from an external billing system that is associated with the system 10 (see FIG. 1). The system administrator 14 accomplishes this by going to the Patients menu 66 on the Patient Administration toolbar 67 and selecting the Add option 68. As described above, the Add option 68 displays two additional options, Manually 170 and Import from file 171. The system administrator 14 selects the Import from file option 171. A window (not shown) is then displayed requesting the new patient's billing ID 70. The system administrator 14 enters the patient's billing ID 70 to add the patient. A module of the software package 13 (see FIG. 1) designed to access the associated external billing system uses the billing ID 70 to locate the patient's information in the database of the external billing system. When found, the module 13 adds the patient to the Patients Table 71 in the database 11 of the system 10. If the module 13 fails to add the patient, notice of this failure is displayed.

Regarding FIG. 17, note that it is possible for the system credentials of users 14 who are not system administrators 14 to be configured so as to allow these users 14 the ability to add new patients to the database 11 of the system 10.

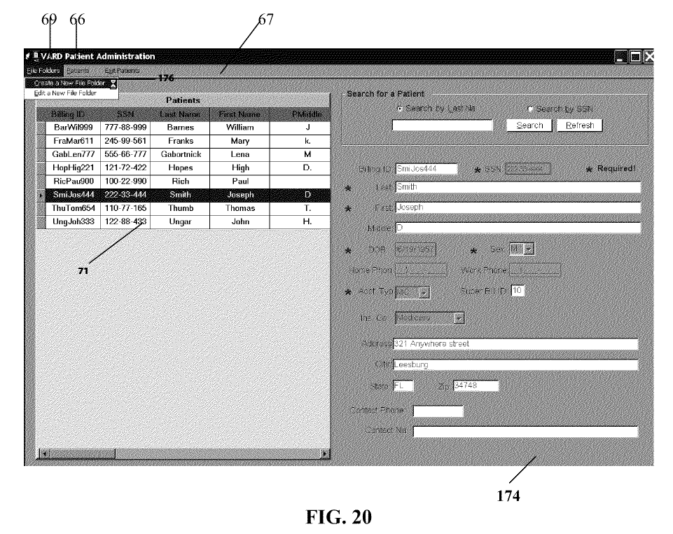

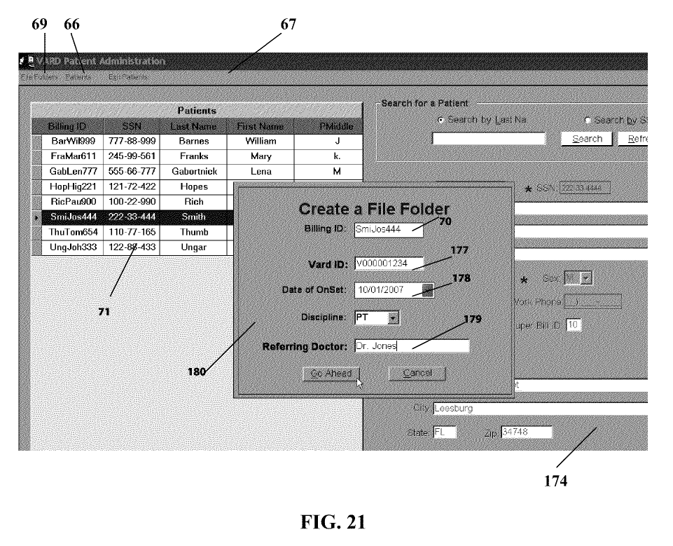

Referring now to FIG. 20, once a patient has been added to the database 11 (see FIG. 1), a new file folder is created for the patient. A file folder is an electronic version of the patient's chart. To add a new file folder for the patient, first the patient's name is chosen from the Patients Table 71. Next, a Create a New File Folder option 176 under a File Folders menu 69 on the Patient Administration toolbar 67 is selected. This brings up a Create a File Folder window 180 (see FIG. 21).

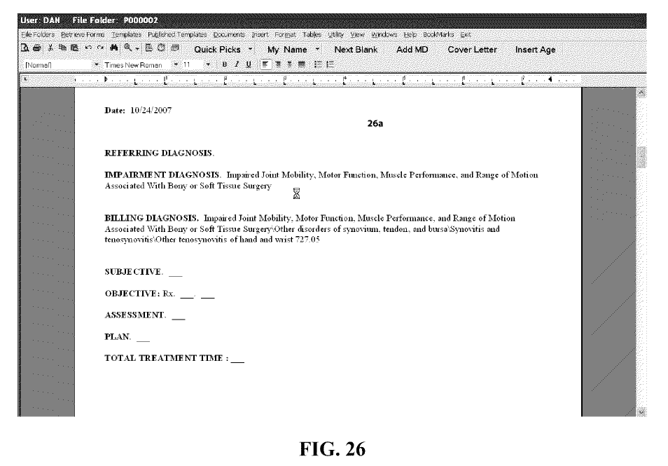

Referring now to FIG. 21, the Create a File Folder window 180 requires entry of the new patients system identification number 177, name of a referring doctor 179, and a date of onset 178. The system administrator 14 (see FIG. 1) then enters these fields 177, 178, 179. The software package 13 (see FIG. 1) notes the combination of the three fields 177, 178, 179 and searches tables in the database 11 (see FIG. 1) for an entry matching this combination of fields 177, 178, 179, as is known in the art. The tables searched are the File Folder Table, the Admissions Table, and the Visits Table. If this combination of fields 177, 178, 179 matches an entry in any of the three tables, a flag is raised preventing the addition of the new file folder. If the combination of fields 177, 178, 179 does not match any entries in the three tables, then the software package 13 adds the new information to the database 11 as a new entry to the File Folders Table, a new entry to the Admissions Table, and a new entry to the Visits Table. A therapist 14 can now prepare an electronic evaluation 26a (see FIG. 26) for the patient.

Regarding FIG. 21, note that it is possible for the system credentials of users 14 who are not system administrators 14 to be configured so as to allow these users 14 the ability to add file folders for patients. Note also that a visit date is assigned at billing time.

Referring now to FIG. 1, to create an electronic evaluation 26a (see FIG. 26) for the patient, the therapist 14 must first logon to the system 10. Upon logging onto the system 10 (step 101; see FIG. 2A), the software package 13 consults the database 11 to determine the therapist's 14 discipline, work location, and team assignment (step 102; see FIG. 2A). Note that the software package 13 allows a therapist 14 access to various categories of data and system functionality based upon certain system-defined credentials previously assigned to the therapist 14, as described above with reference to FIG. 3. The system 10 makes screen options and forms available to the therapist 14 based on the therapist's assigned 14 discipline (step 103; see FIG. 2A).

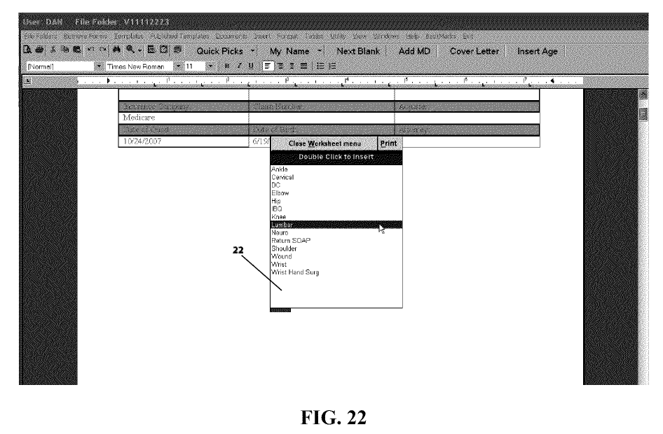

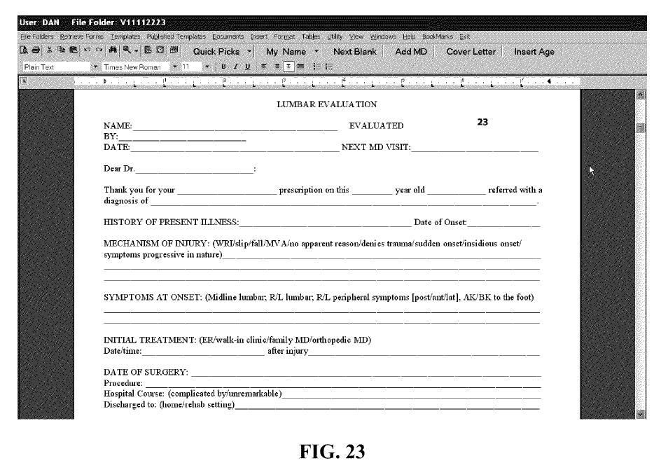

Referring now to FIGS. 22 and 23, optionally the therapist 14 (see FIG. 1) can print a worksheet 23 (see FIG. 23) (step 104; see FIG. 2A) for making manual notes prior to creating an electronic patient evaluation 26a (see FIG. 26). The worksheet 23 to be printed is selected from a list of worksheet options displayed in a Worksheet menu 22 (see FIG. 22). The worksheet 23 can also be inserted into an open document or into the patient's file folder and then printed. FIG. 23 depicts a screen showing a printable worksheet 23. Information in the worksheet 23 is organized in the same order that such information is generally requested from the patient.

Referring now to FIG. 2, the therapist 14 (see FIG. 1) next accesses a drop-down menu from a toolbar, such as known in the art, to request a list of file folders (step 105; see FIG. 2A). As previously mentioned, a file folder is an electronic version of a patient's chart. Note that in some instances it is possible that information in a patient's file folder will have been imported from a scheduling or billing module of the software package 13 (see FIG. 1). Requesting a list of file folders (step 105) causes a list of electronic file folders to be displayed (step 106; see FIG. 2A). The therapist 14 then selects a patient's file folder from the list of folders (step 107; see FIG. 2A). Information from the patient's file folder is then displayed (step 108; see FIG. 2A). Note that in some instances an alert window might appear along with the display of patient information (step 108). The alert window is meant to bring some matter to the attention of the therapist 14. For example, the alert window might notify the therapist 14 that the patient has made a predefined number of visits and that as a result the therapist 14 should send the physician a progress report. At this point, the therapist 14 can update any of the biographical information displayed in the patient's folder (step 109; see FIG. 2A).

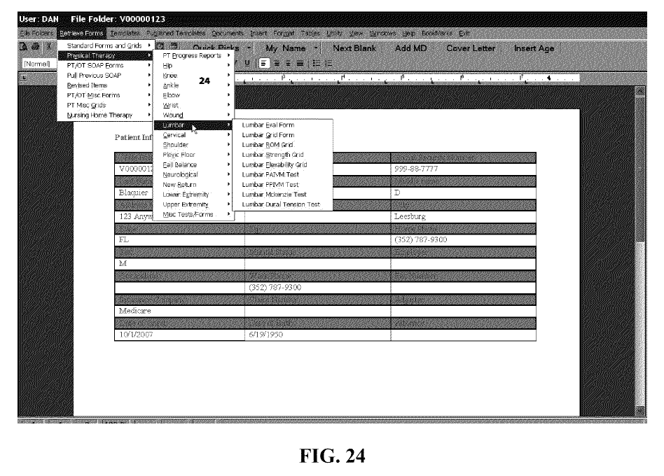

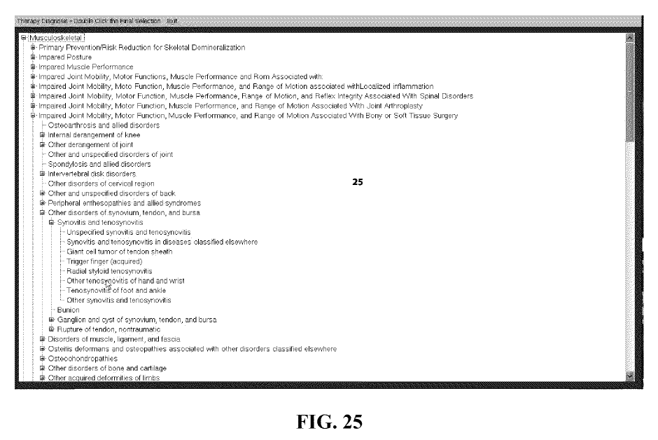

Referring now to FIGS. 24 and 25, the therapist 14 (see FIG. 1) now begins composing the patient evaluation 26a (see FIG. 26) (step 110; see FIG. 2A) by such input means as, for example, voicing or using a mouse. To compose the evaluation 26a, the therapist 14 selects from drop-down menus 24 (see FIG. 24) an appropriate impairment diagnosis (step 111; see FIG. 2A) that corresponds to an International Statistical Classification of Diseases and Related Health Problems (“ICD9”) code. The example shown in FIG. 24 depicts the therapist 14 selecting a Physical Therapy option and a Lumbar option. These selections initiate the loading of therapy diagnosis information (step 112; see FIG. 2A). The therapy diagnosis information shows diagnostic elements such as Musculoskeletal, Neuromuscular Patterns, Cardiovascular/Pulmonary Patterns, and Integumentary Patterns. Selecting the Lumbar option, as shown in FIG. 24, displays a Therapy Diagnosis list 25 (step 113; see FIG. 2A), as shown in FIG. 25.

Referring now to FIG. 26, after the therapist 14 (see FIG. 1) selects an appropriate diagnosis (step 114; see FIG. 2A) from the Therapy Diagnosis list 25 (see FIG. 25), the therapist 14 is offered an opportunity to insert notes into the evaluation 26a (step 115; FIG. 2A). Note that the software package 13 (see FIG. 1) automatically inserts biographical data, such as the patient's age and gender, into the evaluation 26a (step 116; see FIG. 2A). Note also that the therapist 14 can navigate through the evaluation 26a by voice 15 (see FIG. 1), by keyboard 16 (see FIG. 1), or by mouse 17 (see FIG. 1), or by a combination of voice 15, keyboard 16, and mouse 17.

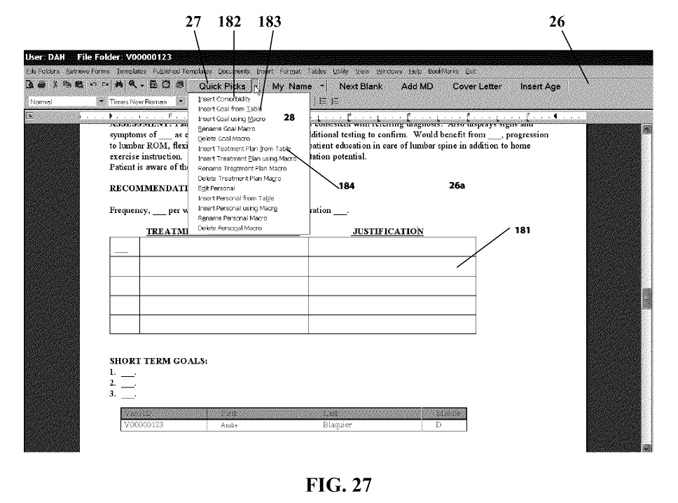

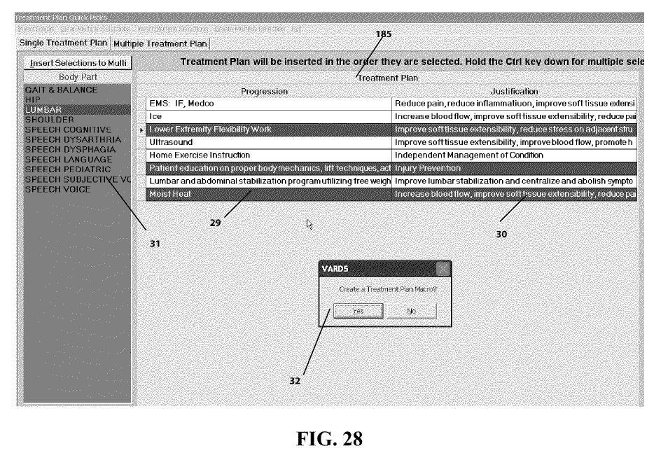

Referring now to FIG. 27, the therapist 14 (see FIG. 1) next enters a treatment plan (step 117; see FIG. 2A) into the evaluation 26a (see FIG. 26). Such a treatment plan is entered into a Treatment Plan table 181. To help with entering a treatment plan, a Quick Picks tab 27 is available on a toolbar 26. The Quick Picks tab 27 displays a drop-down menu 28 presenting the therapist 14 with a list of options, one of which is an Insert Treatment Plan from Table option 184. Note that the table referred to in the option 184 is a table of treatment plans that includes treatment plans created as described above with reference to FIG. 13. Selecting the Insert Treatment Plan from Table option 184 displays a table of treatment plans 185 (see FIG. 28).

Referring now to FIG. 28, the therapist 14 (see FIG. 1) selects one or more treatment plans from the displayed table of treatment plans 185 (step 118; see FIG. 2A) on a Treatment Plan Quick Picks screen. Each treatment plan includes a progression element 29 and a corresponding justification 30. The treatment plans are inserted into the Treatment Plan table 181 (see FIG. 27) of the evaluation 26a (see FIGS. 26 and 27) in the order in which they are selected. Note that the therapist 14 may optionally make selections from a Body Part list 31 as well.

Continuing with FIG. 28, at this point the therapist 14 can optionally create a Treatment Plan macro 32 (step 119; see FIG. 2A). The Treatment Plan macro 32 can be created so as to be associated with a voice command. Simply speaking the associated voice command will then automatically open the Treatment Plan macro 32. When opened, the Treatment Plan macro 32 selects the treatment progression elements 29 and the corresponding justifications 30 in the exact order that the therapist 14 had previously selected them and fills in the Treatment Plan table 181 of the patient evaluation 26a. The therapist 14 can then customize any of these treatment plans for the specific patient being treated.

Still referring to FIG. 28, the system 10 (see FIG. 1) can also provide the therapist 14 with a list of exercises that the therapist 14 might incorporate into the patient's therapy. The therapist 14 can print a paper copy of an exercise grid of selected exercises for use when working with the patient. Later, the paper copy of the exercise grid can be scanned into the patient's file folder.

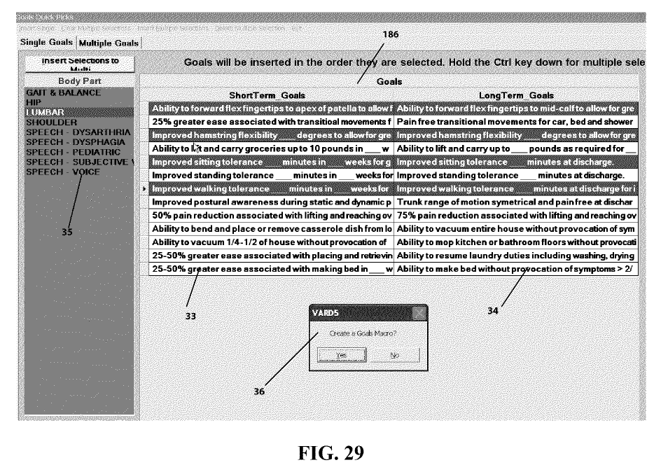

Referring now to FIG. 29, the therapist 14 (see FIG. 1) next enters one or more long-term goals, short-term goals, or both long-term and short-term goals (step 120; see FIG. 2B) into the evaluation 26a (see FIGS. 26 and 27). To help with entering a goal, a Quick Picks tab 27 (see FIG. 27) is available. The Quick Picks tab 27 displays a drop-down menu 28 (see FIG. 27) presenting the therapist 14 with a list of options, one of which is an Insert Goal from Table option 183 (see FIG. 27). Note that the table referred to in the option 183 is a table of goals that includes goals created as described above with reference to FIG. 14. Selecting the Insert Goal from Table option 183 displays a table of goals 186.

Continuing with FIG. 29, the therapist 14 selects one or more goals from the displayed table of goals 186 on a Goals Quick Picks screen. The table of goals 186 includes both short-term goals 33 and corresponding long-term goals 34. The goals are inserted into the evaluation 26a in the order in which they are selected. Note that the therapist 14 may optionally make selections from a Body Part list 35 as well.

Still referring to FIG. 29, at this point the therapist 14 can optionally create a Goals macro 36 (step 121; see FIG. 2B). The Goals macro 36 can be created so as to be associated with a voice command. Simply speaking the associated voice command will then automatically open the Goals macro 36. When opened, the Goals macro 36 selects the short-term goals 33 and corresponding long-term goals 34 in the exact order that the therapist 14 had previously selected them and populates the short-term goals and long-term goals section of the patient evaluation 26a (step 122; see FIG. 2B). The therapist 14 can customize any of these goals for the specific patient being treated.

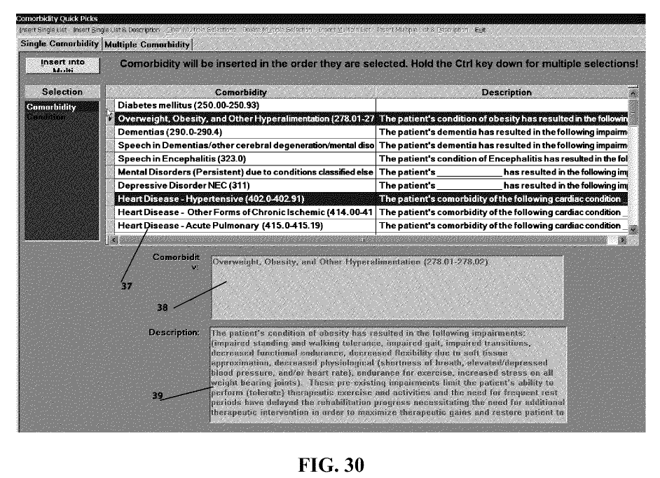

Referring now to FIG. 30, if the therapist 14 (see FIG. 1) has identified any complicating conditions or comorbidities that might affect a patient's speed of recovery, the therapist 14 next enters those conditions or comorbidities into the evaluation 26a (see FIGS. 26 and 27). To help with entering a comorbidity, a Quick Picks tab 27 (see FIG. 27) is available. The Quick Picks tab 27 displays a drop-down menu 28 (see FIG. 27) presenting the therapist 14 with a list of options, one of which is an Insert Comorbidity option 182 (see FIG. 27). Note that the comorbidities referred to in the option 182 include comorbidities created as described above with reference to FIG. 15. Selecting the Insert Comorbidity option 182 displays a list of comorbidities 37 (step 123; see FIG. 2B).

Continuing with FIG. 30, the therapist 14 selects one or more comorbidities 38 from the displayed list of comorbidities 37 on a Comorbidity Quick Picks screen (step 124; see FIG. 2B). Note that a description 39 of a selected comorbidity 38 is displayed on the screen. The comorbidities 38 are then inserted into the evaluation 26a in the order in which they are selected, populating a conditions/comorbidities section of the patient evaluation 26a (step 125; see FIG. 2B).

Still referring to FIG. 30, at this point if the therapist 14 has identified any conditions or comorbidities, then those will have been entered into the patient evaluation 26a along with their associated ICD9 codes. After the therapist 14 has worked with the patient, the therapist 14 might determine which of the conditions and comorbidities could impact the patient's speed of recovery (step 126; see FIG. 2B). In this event, a more detailed description can be added to the evaluation 26a (step 127; see FIG. 2B). Note that here again the Insert Comorbidity option 182 can be selected to aid in entering comorbidity information into the patient evaluation 26a. The therapist 14 can then customize any of the comorbidity information for the specific patient being treated.

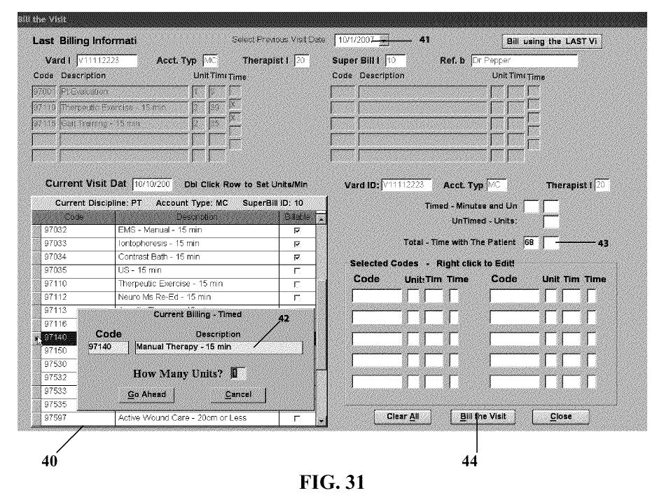

Referring now to FIG. 31, following a patient's visit the therapist 14 (see FIG. 1) can use a billing utility to select the appropriate CPT items for which to bill 40 (step 128; see FIG. 2B). For proper billing, the therapist 14 enters the date of the current visit 41, the time spent with the patient 42, and the number of units performed 43. If the item to be billed has a timed procedure code associated with it, then the actual number of minutes of therapy delivered is entered. This procedure continues for all of the items that were performed and that are to be billed. After all entry is completed, the therapist 14 clicks a button 44 to bill the visit (step 129; see FIG. 2B), and the billing date is confirmed.

Regarding FIG. 31, note that a module of the software package 13 (see FIG. 1) is designed to prompt the therapist 14 to enter the time the therapist 14 spent treating the patient. The module 13 will then automatically calculate the correct number of units performed and notify the therapist 14 if there is an error.

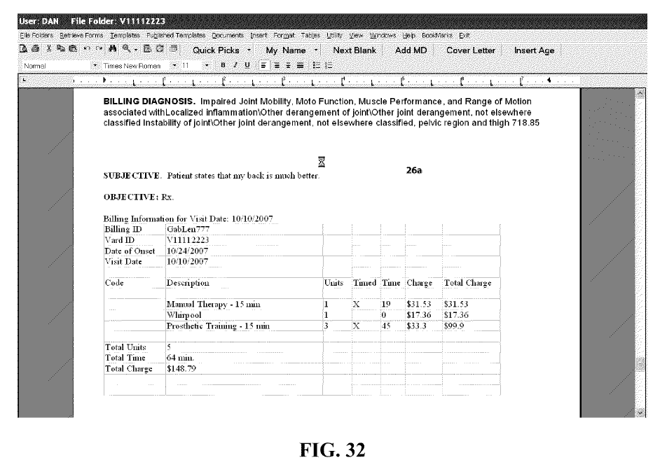

Referring now to FIG. 32, the billing information is now automatically entered into the patient evaluation 26a (step 130; see FIG. 2B). The billing information is also populated in the billing database and made available to the billing program (step 131; see FIG. 2B).

Referring now to FIG. 1, another feature provided by the software package 13 of the system 10 is a template creation tool that allows the therapist 14, and other users 14, to create customized text that can be inserted into selected screens and forms.

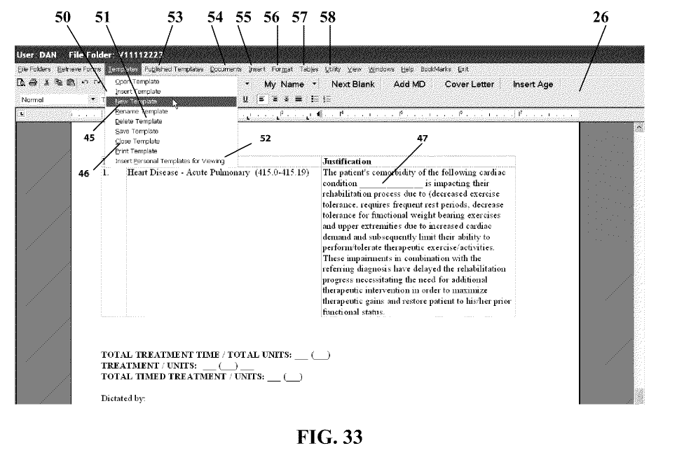

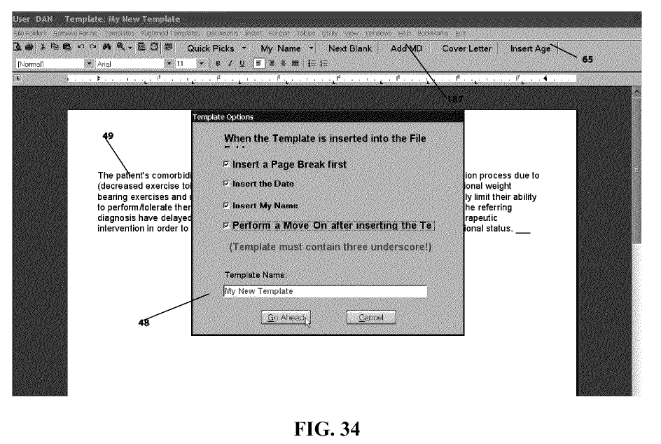

Referring now to FIG. 33, to create a template 49 (see FIG. 34) the therapist 14 (see FIG. 1) first selects a New Template option 45 from the Templates drop-down menu 46 on the toolbar 26. The therapist 14 is then prompted to enter a name for the new template 49. The name can be entered by voice, keyboard, or other like means. When creating the template 49 the therapist 14 is permitted to create blanks 47 in the template 49 that can be filled in later. The template 49 is then closed and saved.

Referring now to FIG. 34, the template creation tool displays an option box 48 that appears over the text of the template 49 to specify whether the new template 49 will start on the top of a new page, whether the system will automatically insert the current date, and whether the therapist's 14 (see FIG. 1) predefined name and credentials will be inserted at the end of the template 49. If the therapist 14 created any blanks in the template 49, the tool will seek out the first blank and place the insertion point in that position so that the therapist 14 can begin entering text into the template 49 there.

Referring now to FIG. 33, the therapist 14 (see FIG. 1) may insert a template 49 (see FIG. 34) into a screen by using a voice command or a mouse. To insert the template 49, an Insert Template option 50 from the Templates drop-down menu 46 is selected. A list of templates 49 will then appear from which the therapist 14 can select the desired template 49 for insertion.

Referring now to FIG. 34, a template 49 may also be modified. To do so, a therapist 14 (see FIG. 1) opens the desired template 49, modifies the template 49, and then closes and saves the template 49 with the modifications. As described above, the therapist 14 can choose whether the modified template 49 will start on the top of a new page, whether the system will automatically insert the current date, and whether the therapist's 14 predefined name and credentials will be inserted at the end of the template 49.

Referring now to FIG. 33, a template 49 (see FIG. 34) may be deleted from the system by clicking a Delete Template option 51 from the Templates drop-down menu 46. A template is then selected from a list of templates 49 and a Delete button clicked.

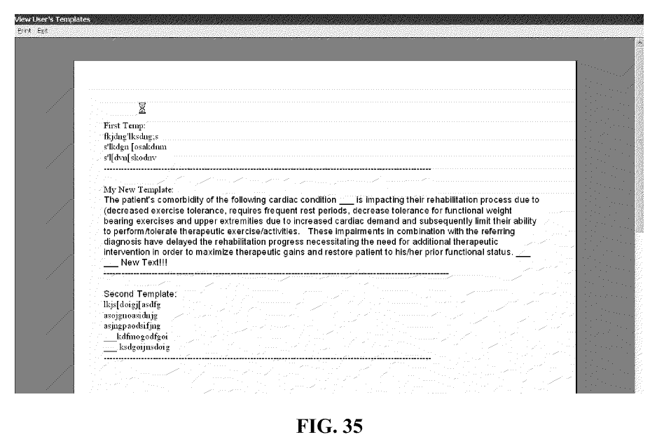

Referring now to FIGS. 33 and 35, another software tool is provided that allows for the viewing of an individual therapist's 14 (see FIG. 1) templates 49 (see FIG. 34). The therapist's 14 templates 49 can be accessed by selecting an Insert Personal Templates for Viewing option 52 (see FIG. 33) on the Templates drop-down menu 46 (see FIG. 33). A User's Templates screen (see FIG. 35) is then displayed with the name of the therapist's 14 templates 49 listed in alphabetical order. A portion of each template 49 is shown followed by a dotted line to separate the templates 49.

Referring now to FIG. 33, in a preferred embodiment templates 49 (see FIG. 34) are stored in the database 11 (see FIG. 1) but are available only to a specific user 14 (see FIG. 1) when that user 14 is logged onto the system 10 (see FIG. 1). If the user 14 wishes to share one or more templates 49 with other users 14 on the network 60 (see FIG. 1), however, a Published Templates utility can be accessed from a Published Templates tab 53. A published template 49 can be created, inserted, modified, renamed, saved, and closed in a fashion similar to that of unpublished templates 49. Published templates 49, however, can be accessed by all users 14 on the network 60.

Continuing with FIG. 33, there may be situations when a user 14 wishes to create personal documents that are not a part of any patient's record. For example, a chief therapist 14 might want to write a letter to colleagues concerning a continuing education class. The user 14 may create these documents using a Personal Document utility located under a Documents tab 54. A personal document can be created, inserted, modified, renamed, saved, and closed in a fashion similar to that of templates 49 (see FIG. 34).

Still referring to FIG. 33, an insert feature 55 allows the user 14 to insert files or images into a template 49 (see FIG. 34), document, or patient record. The insert feature can be accessed from an Insert tab 55 on the toolbar 26. Another feature, called a format feature, allows the user 14 to modify text within a template 49, document, or patient record. The format feature can be accessed from a Format tab 56 on the toolbar 26. Yet another feature, called a tables feature, allows the user 14 to insert tables 57 into a template 49, document, or patient record. The tables feature can be accessed from a Tables tab 57 on the toolbar 26.

Continuing with FIG. 33, the system 10 also comprises a plurality of utilities. When a user 14 logs onto the system 10, forms and menu selections are presented that are discipline specific. For example, a physical therapist will see physical therapy forms and evaluations, but will not see speech therapy forms and evaluations. If the therapist 14 wishes to see forms from other disciplines, however, the therapist 14 may access a utility under the Utility tab 58 on the toolbar 26 that resets the forms menu to show PT (physical therapy), OT (occupational therapy), SLP (speech and language pathology), or ALL FORMS. Menu selections will then change to provide access to the desired content.

Still referring to FIG. 33, another utility is used to update timesheets. This utility is also accessible via the Utility tab 58. When using this utility, a time period is selected and the therapist 14 keys in his/her time. Note that if the therapist 14 is salaried, his/her effective time can differ from actual time expended. The timesheet can then be saved, and the timesheet utility exited. One more utility is accessible by selecting a List Voice Commands option under the Utility tab 58. This utility provides users 14 with a quick reference to available voice commands.

Referring now to FIG. 1, in a particular embodiment voice model files can reside on an individual computer 69 on a network 60 in signal communication with the main processor 12. In this configuration, a user 14 can back up the voice files to the central server 12 using a utility that provides two important functions. First, the utility backs up data on the server 12, including the user's 14 voice model, generally each night. Second, the utility allows the user 14 to download a voice model to a different computer 59 on the network 60.

Continuing with FIG. 1, if the user 14 wants to copy such files as voice model files, templates 49 (see FIG. 34), documents, or custom voice commands to a location outside of the network 60, a utility can back up the files to a storage medium, such as a CD or DVD, so that these files can be transported to the new location.

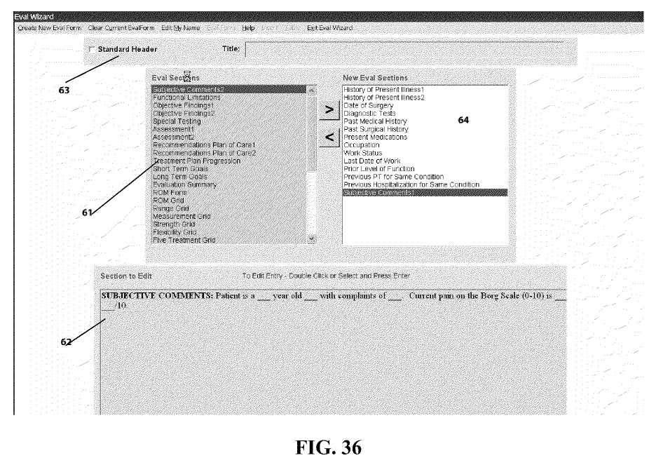

Referring now to FIG. 36, another utility accessible from the Utility tab 68 (see FIG. 33) of the toolbar 26 (see FIG. 33) is an Eval Wizard. The Eval Wizard allows the user 14 (see FIG. 1) to create customizable patient evaluations 26a (see FIGS. 7 and 8) that permit data mining. The user 14 selects sections 61 of the evaluation 26a, which are then displayed with preformafted text 62 and that can be modified by the user 14. Areas of a patient evaluation 26a that differ greatly based upon a body part have an exploded sub-application that allows for easy modification. These sections are completely customizable by the user 14. Once text is modified to the user's 14 satisfaction, the user 14 can save the text, and the new section 64 is added to the evaluation 26a. A custom header 63 can also be added to the top of the evaluation 26a. Once finished, the user 14 saves the new evaluation 26a.

Referring now to FIG. 34, often a therapist 14 (see FIG. 1) needs to insert a Patient's age into a document. This is accomplished by using a utility accessible from an Insert Age tab 65. The utility calculates the patient's age based on the current date and inserts the result into the document. Another utility creates a user-defined letter that thanks a referring physician for a referral. This utility is accessible from the Add MD tab 187. The text of the letter is customizable by the user 14.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the system and method illustrated and described herein are by way of example, and the scope of the invention is not limited to the exact details of construction and use.

What is claimed as new, and what it is desired to secure by Letters Patent of the United States, is:

1. A system for creating and maintaining medical records comprising:
a database;
input means for entering patient and treatment data into the database and for issuing instructions to the system;
a software module interposed between the database and the input means for facilitating entry of the patient and treatment data into the database in accordance with predetermined criteria;
communication means for interfacing with the database;
electronic templates within the database for automatically populating data fields used in updating the patient and treatment data; and
command means for creating and maintaining electronic templates and for providing visual representations of the templates.

2. The system recited in claim 1, wherein the input means comprise at least one of a keyboard, a microphone, a mouse, a touch screen, a scanning device, and a biometric device.

3. The system recited in claim 2, wherein the communication means comprise a network for use by a user remote from the database.

4. The system recited in claim 3, wherein the command means comprise voice commands conveyed via the input means.

5. The system recited in claim 4, wherein the templates comprise a diagnosis template for recording diagnoses for a patient's malady, a treatment plan template for identifying appropriate treatments for the patient's malady, and a goals template for identifying goals for the patient's treatment.

6. The system recited in claim 5, wherein the templates further comprise a comorbidity template for identifying coexisting or additional disease in the patient that can impact the patient's malady.

7. The system recited in claim 6, wherein the templates further comprise means for providing an inclusion of data areas void of meaningful system information into which meaningful system information can later be added.

8. The system recited in claim 2, wherein the templates comprise a diagnosis template for recording diagnoses for a patient's malady, a treatment plan template for identifying appropriate treatments for the patient's malady, and a goals template for identifying goals for the patient's treatment.

9. The system recited in claim 8, wherein the templates further comprise a comorbidity template for identifying coexisting or additional disease in the patient that can impact the patient's malady.

10. The system recited in claim 9, wherein the command means comprise voice commands conveyed via the input means.

11. The system recited in claim 2, wherein the templates further comprise means for providing an inclusion of data areas void of meaningful system information into which meaningful system information can later be added.

12. The system recited in claim 2, wherein the command means comprise voice commands conveyed via the input means.

13. A method for creating and maintaining medical records, the method comprising the steps of:
providing a medical records system database;
electronically requesting a list of patients from the database;
electronically selecting a patient from the list of patients;
creating an electronic evaluation for the patient;
printing the electronic patient evaluation; and
billing for patient treatment using data from the electronic patient evaluation.

14. The method of claim 13, further comprising the step of modifying the electronic patient evaluation.

15. The method of claim 14, further comprising the step of creating at least one electronic template in the database for updating the medical records of the patient.

16. The method of claim 15, further comprising the step of updating at least one of the templates to include meaningful system information in at least one data area left void of meaningful system information by the template.

17. The method of claim 16, wherein the step of modifying the electronic patient evaluation comprises creating at least one reusable electronic template of updates from updates performed on the electronic patient evaluation for updating a future electronic patient evaluation.

18. The method of claim 17, wherein the step of modifying the electronic patient evaluation comprises updating the electronic patient evaluation using at least one of the reusable electronic templates of updates.

19. The method of claim 13, wherein the step of creating the electronic patient evaluation comprises creating at least one reusable electronic template of updates from updates performed on the electronic patient evaluation for updating a future electronic patient evaluation.

20. The method of claim 19, wherein the step of creating the electronic patient evaluation comprises updating the electronic patient evaluation using at least one of the reusable electronic templates of updates.

21. The method of claim 13, wherein the step of billing for patient treatment comprises using data retrieved from an external billing system.

22. The method of claim 13, further comprising the step of printing an electronic worksheet for manually recording notes.

23. A method for creating and maintaining medical records, the method comprising the steps of:
providing a medical records system database, the database having electronic templates for updating the medical records of the patient including a diagnosis template for recording diagnoses for a patient's malady, a treatment plan template for identifying appropriate treatments for the patient's malady, and a goals template for identifying goals for the patient's treatment;
electronically requesting a list of patients from the database;
electronically selecting a patient from the list of patients;
providing an electronic evaluation for the patient;
employing the diagnosis template to modify the electronic patient evaluation;
employing the treatment plan template to modify the electronic patient evaluation; and
employing the goals template to modify the electronic patient evaluation.

24. The method of claim 23, further comprising the steps of:
providing an electronic comorbidity template for identifying coexisting or additional disease in the patient that can impact the patient's malady; and
employing the comorbidity template to modify the electronic patient evaluation.
